(19) United States
(12) Patent Application Publication
(10) Pub. No.: US 2026/0147519 A1
(43) Pub. Date: May 28, 2026

(54) CONTROL METHOD FOR INFORMATION PROCESSING DEVICE, DISPLAY SYSTEM, AND NON-TRANSITORY COMPUTER READABLE STORAGE MEDIUM STORING PROGRAM

(71) Applicant: SEIKO EPSON CORPORATION, Tokyo (JP)

(72) Inventor: Kensuke KIDA, MATSUMOTO-SHI (JP)

(21) Appl. No.: 19/400,696

(22) Filed: Nov. 25, 2025

(30) Foreign Application Priority Data
Nov. 28, 2024 (JP) 2024-207467

(51) Int. Cl. G06F 3/14; G06K 19/06

(52) U.S. Cl. CPC G06F 3/1454; G06K 19/06037

(57) ABSTRACT

A control method for an information processing device connected to an infrastructure network, the control method including acquiring, via the infrastructure network, identification information of a first display device connected to the infrastructure network and identification information of a second display device connected to the infrastructure network; by reading an identification code displayed by a display device to which a user wants to connect, acquiring identification information of the display device from the identification code; and when the identification information of the display device and the identification information of the first display device match each other, connecting, via the infrastructure network, to the first display device as the display device.

The present application is based on, and claims priority from, JP Application Serial Number 2024-207467, filed Nov. 28, 2024, the disclosure of which is hereby incorporated by reference herein in its entirety.

### BACKGROUND

### 1. Technical Field

The present disclosure relates to a control method for an information processing device, a display system, and a program.

### 2. Related Art

In the related art, a technique for connecting a display device and an information processing device via an infrastructure network is known. For example, JP-A-2012-191411 discloses an image generation system in which a projector is selected from a list image indicating an SSID or a radio wave intensity, and the selected projector and a PC are connected to each other via an access point.

In the list image described in JP-A-2012-191411, a user can estimate which projector is wanted to be connected from the radio wave intensity or the like. However, since the user can only estimate, JP-A-2012-191411 does not necessarily mean that the projector selected in the list image is the projector the user wants to connect to. Therefore, in the technique described in JP-A-2012-191411, there is a concern that a projector and a PC, which the user does not desire to connect, may be connected to each other.

### SUMMARY

A control method for an information processing device according to the present disclosure is a control method for the information processing device connected to an infrastructure network, the control method including acquiring, via the infrastructure network, identification information of a first display device connected to the infrastructure network and identification information of a second display device connected to the infrastructure network; by reading an identification code displayed by a display device to which a user wants to connect, acquiring identification information of the display device from the identification code; and when the identification information of the display device and the identification information of the first display device match each other, connecting, via the infrastructure network, to the first display device as the display device.

A display system according to the present disclosure includes an information processing device and display devices that are connected to an infrastructure network, wherein the information processing device acquires, via the infrastructure network, identification information of a first display device connected to the infrastructure network and identification information of a second display device connected to the infrastructure network, by reading an identification code displayed by a display device to which a user wants to connect, acquires identification information of the display device from the identification code; and when the identification information of the display device and the identification information of the first display device match each other, connecting, via the infrastructure network, to the first display device as the display device.

A non-transitory computer-readable storage medium storing a program of the present disclosure, the program causes a processor of an information processing device connected to an infrastructure network to acquire identification information of a first display device connected to the infrastructure network and identification information of a second display device connected to the infrastructure network via the infrastructure network, acquire identification information of the display device from an identification code by reading the identification code displayed by a display device to which a user wants to connect, and when the identification information of the display device and the identification information of the first display device match each other, connect, via the infrastructure network, to the first display device as the display device.

### BRIEF DESCRIPTION OF THE DRAWINGS

FIG. 1 is a diagram illustrating a configuration of a

projection system.

FIG. 2 is a block diagram illustrating a configuration of a projector.

FIG. 3 is a block diagram illustrating a configuration of an information processing device.

FIG. 4 is a flowchart illustrating an operation of the information processing device.

FIG. 5 is a diagram illustrating an example of a code screen.

### DESCRIPTION OF EMBODIMENTS

### 1. Configuration of Projection System

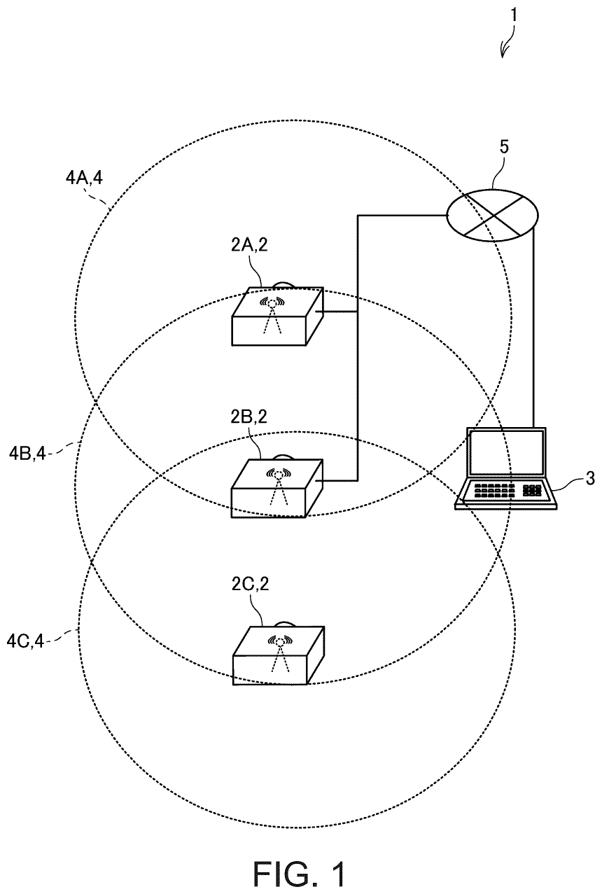

FIG. 1 is a diagram showing configuration of a projection system 1.

The projection system 1 includes a projector 2 and an information processing device 3.

The projection system 1 is an example of a “display system”. The projector 2 is an example of a “display device”.

The projector 2 receives image data from the information processing device 3 and generates image light based on the image represented by the received image data. The projector 2 projects the image by emitting the generated image light to a projection surface. Note that examples of the projection surface on which the projector 2 projects the image include a curtain-like screen and a wall surface of a building.

The information processing device 3 transmits the image data of the image to be projected by the projector 2 to the projector 2, and corrects the shape of the image to be projected by the projector 2. The information processing device 3 illustrated in FIG. 1 is a notebook type Personal Computer (PC). Note that the information processing device 3 is not limited to a notebook type PC, and may be an electronic device such as a desktop type PC, a tablet terminal, or a smartphone.

The information processing device 3 according to the present embodiment is connected to the projector 2 via an ad-hoc network 4 or an infrastructure network 5. Note that in the present embodiment, connection to the projector 2 means a connection so that the image data can be transmitted to the projector 2.

The ad-hoc network 4 is a network in which wireless communication devices directly communicate with each other. The ad-hoc network 4 is a network of a smaller scale than the infrastructure network 5. In the present embodiment, the ad-hoc network 4 is constructed by the projector 2 functioning as an access point.

The infrastructure network 5 is a network in which wireless communication devices communicate with each other via the access points. The infrastructure network 5 is a larger scale network compared to the ad-hoc network 4. Note that in the present embodiment, a wireless network is exemplified as the infrastructure network 5, but the infrastructure network 5 may be a wired network.

In FIG. 1, three projectors 2 are illustrated.

The projectors 2A and 2B are projectors 2 that can be connected via the ad-hoc network 4B. The projectors 2A and 2B are connected to the infrastructure network 5 to which the information processing device 3 is connected. The projectors 2A and 2B themselves function as access points. The projector 2A constructs an ad-hoc network 4A of Service Set Identifier (SSID) according to a predetermined rule. The SSID of the ad-hoc network 4A constructed by the projector 2A include identification information of the projector 2A. The projector 2B also constructs an ad-hoc network 4B of SSID according to a predetermined rule. The SSID of the ad-hoc network 4B constructed by the projector 2B include identification information of the projector 2B. Note that, as the identification information of the projector 2, there is cited a projector name indicating the name of the projector 2 as an example.

Note that in the case in which the projector 2A is an example of the “first display device”, the projector 2B is an example of the “second display device”. In the case in which the projector 2B is an example of the “first display device”, the projector 2A is an example of the “second display device”.

The projector 2C is the projector 2 that can be connected via the ad-hoc network 4. The projector 2C is not connected to the infrastructure network 5 to which the information processing device 3 is connected. Note that the projector 2C may be connected to an infrastructure network different from the infrastructure network 5 to which the information processing device 3 is connected. The projector 2C is the projector 2C itself functions as the access point. The projector 2C constructs the SSID ad-hoc network 4C according to a predetermined rule. The SSID of the ad-hoc network 4A constructed by the projector 2C includes the identification information of the projector 2C.

### 2. Configurations of Projector and Information Processing Device

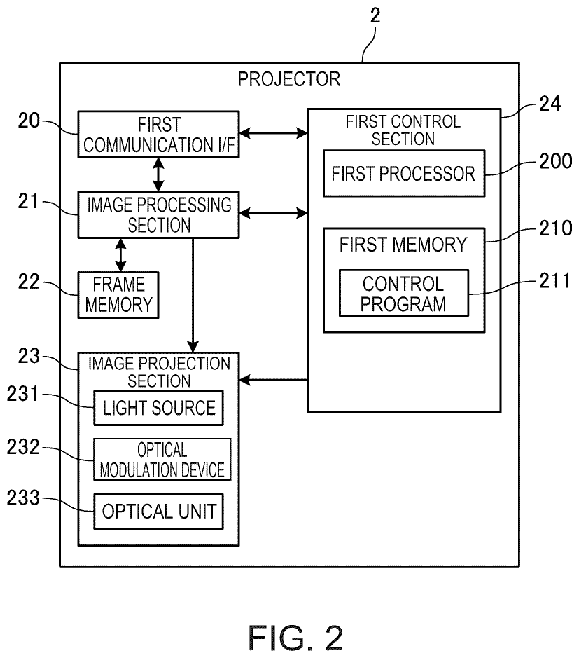

Next, the configuration of the projector 2 will be described with reference to FIG. 2.

FIG. 2 is a block diagram illustrating the configuration of the projector 2.

The projector 2 includes a first communication interface 20, an image processing section 21, a frame memory 22, an image projection section 23, and a first control section 24. Hereinafter, interface is abbreviated as I/F.

The first communication I/F 20 includes, for example, a wired interface that has connection terminals such as a Universal Serial Bus (USB) connector and an Ethernet connector, and that has an interface circuit. The Ethernet is a registered trademark.

The first communication I/F 20 includes a wireless interface having an interface circuit or the like conforming to the Wi-Fi standard, for example. The Wi-Fi is a registered trademark.

In the case in which the projector 2 functions as the access point, the first communication I/F 20 includes the wireless interface having the interface circuit or the like conforming to the Wi-Fi Direct standard, for example. The Wi-Fi Direct is a registered trademark.

The frame memory 22 is connected to the image processing section 21. The frame memory 22 includes a plurality of banks. Each bank has a storage capacity capable of writing a display image of one frame. The frame memory 22 is configured by, for example, a Synchronous Dynamic RAM (SDRAM). The image processing section 21 develops the image input from the first communication I/F 20 in the frame memory 22.

The image processing section 21 performs image processes on the image developed in the frame memory 22. The image process performed by the image processing section 21 includes, for example, a resolution conversion process or a resizing process, a distortion aberration correction, a shape correction process, a digital zoom process, an adjustment of the color tone and brightness of an image, and the like. The image processing section 21 executes the process designated by the first control section 24, and performs the process using a parameter input from the first control section 24 as necessary. The image processing section 21 can of course execute a combination of a plurality of image processes among the above.

The image processing section 21 and the frame memory 22 are each configured by, for example, an integrated circuit. The integrated circuit includes a Large Scale Integration (LSI), an Application Specific Integrated Circuit (ASIC), a Programmable Logic Device (PLD), a Field-Programmable Gate Array (FPGA), a System-on-a-Chip (SoC), and the like. An analog circuit may be included in a part of the configuration of the integrated circuit, or the first control section 24 and the integrated circuit may be combined.

The image projection section 23 includes a light source 231, a light modulation device 232, and an optical unit 233.

The light source 231 includes a discharge type light source lamp such as an ultra-high pressure mercury lamp or a metal halide lamp, or a solid-state light source such as a light emitting diode or a semiconductor laser. The light emitted from the light source 231 enters the light modulation device 232.

The light modulation device 232 includes a transmissive liquid crystal panel in which liquid crystal is sealed between a pair of transparent substrates as a light modulation element that modulates the light emitted from the light source 231. The liquid crystal panel is not illustrated. The liquid crystal panel includes a panel region including a plurality of pixels arranged in a matrix. The light modulation device 232 applies a drive voltage corresponding to the image input from the image processing section 21 to each pixel in the panel region to change the light transmittance of each pixel to a transmittance corresponding to the display image. The light emitted from the light source 231 is transmitted through the liquid crystal panel, whereby the light is modulated, and the image light corresponding to the image to be projected is generated.

The light modulation element included in the light modulation device 232 is not limited to the transmissive liquid crystal panel, and may be, for example, a reflective liquid crystal panel or a Digital Micromirror Device (DMD).

The optical unit 233 includes a projection lens (not illustrated) and the like, and emits the image light modulated by the light modulation device 232.

The first control section 24 is a computer device including a first processor 200 such as a Central Processing Unit (CPU) or a Micro Processing Unit (MPU), and a first memory 210.

The first memory 210 is a storage device that stores programs and data. The first memory 210 stores a control program 211, data processed by the first processor 200, and the like. The first memory 210 has a non-volatile storage region. The first memory 210 includes a volatile storage region and constitutes a work area of the first processor 200. The first memory 210 is configured by, for example, a Read Only Memory (ROM) or a Random Access Memory (RAM).

The first processor 200 executes the control program 211 stored in the first memory 210 to cause the image processing section 21 and the image projection section 23 to project the image supplied from the information processing device 3 on the projection surface.

The first processor 200 executes the control program 211 stored in the first memory 210, and thereby, when a device search packet (to be described later) is received by the first communication I/F 20, transmits a response packet by the first communication I/F 20. The response packet includes the identification information of the projector 2.

When the projector 2 functions as the access point, the first processor 200 executes the control program 211 stored in the first memory 210, thereby constructing the ad-hoc network 4 by the first communication I/F 20.

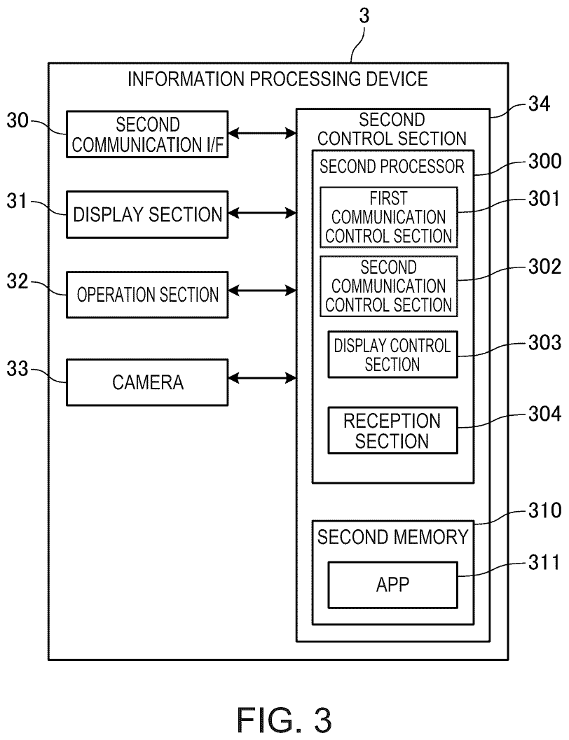

Next, a configuration of the information processing device 3 will be described with reference to FIG. 3.

FIG. 3 is a block diagram illustrating the configuration of the information processing device 3.

The information processing device 3 includes a second communication I/F 30, a display section 31, an operation section 32, a camera 33, and a second control section 34.

The second communication I/F 30 includes, for example, a wired interface that has connection terminals such as a USB connector and a Ethernet connector, and that has an interface circuit.

The second communication I/F 30 includes a wireless interface having an interface circuit or the like conforming to the Wi-Fi standard, for example.

The second communication I/F 30 includes the wireless interface having the interface circuit or the like conforming to the Wi-Fi Direct standard, for example.

The display section 31 includes a display such as a liquid crystal display or an Electro Luminescence (organic EL) display.

The operation section 32 includes an input device such as a mouse or a keyboard, and receives an operation of the user. The operation section 32 outputs an operation signal corresponding to the received operation to the second control section 34.

The camera 33 performs imaging under the control of the second control section 34. The camera 33 outputs image data of the imaged image obtained by the imaging to the second control section 34.

The second control section 34 is a computer device including a second processor 300 such as a CPU or an MPU, and a second memory 310.

The second processor 300 is an example of a “processor”.

The second memory 310 is a storage device that stores programs and data. The second memory 310 stores an application program 311, data processed by the second processor 300, and the like. The second memory 310 has a non-volatile storage region. The second memory 310 includes a volatile storage region and constitutes a work area of the second processor 300. The second memory 310 is configured by, for example, a ROM or a RAM. Hereinafter, the application program 311 is referred to as the APP 311.

The APP 311 is an example of a “program”.

By reading and executing the APP 311 stored in the second memory 310, the second processor 300 functions as a first communication control section 301, a second communication control section 302, an identification information processing section 303, and a reception section 304.

The first communication control section 301 is connected to the projector 2 via the ad-hoc network 4 by the second communication I/F 30 based on the SSID acquired by the identification information processing section 303 (will be described later). When the first communication control section 301 is connected to the projector 2 via the ad-hoc network 4, it communicates with the projector 2 via the ad-hoc network 4 by the second communication I/F 30.

The second communication control section 302 broadcasts a device search packet conforming to the communication protocols of the projector 2 to the infrastructure network 5 by the second communication I/F 30. When the device search packet is broadcast, the second communication control section 302 receives a response packet to the device search packet for a certain period of time after the broadcast. When the second communication control section 302 receives the response packet, the second communication control section 122 acquires the identification information of the projector 2 from the received response packet.

When the second communication control section 302 is connected to the projector 2 via the infrastructure network 5, it communicates with the projector 2 via the infrastructure network 5 by the second communication I/F 30.

The second communication control section 302 communicates with devices other than the projector 2 via the infrastructure network 5 by the second communication I/F 30. Examples of the device other than the projector 2 include a device that holds data downloaded by the information processing device 3.

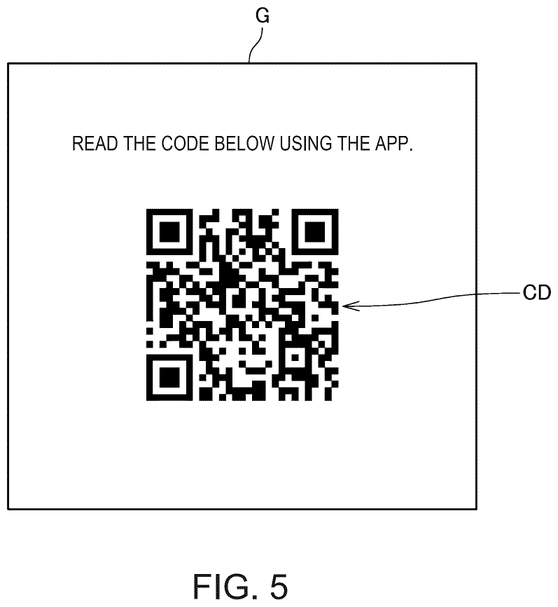

The identification information processing section 303 drives the camera 33 to cause the camera 33 to perform imaging. When an identification code CD is included in the imaged image indicated by the image data received from the camera 33, the identification information processing section 303 reads the identification code CD from the imaged image to acquire the SSID from the identification code CD. The identification information processing section 303 then acquires the identification information of the projector 2 from the acquired SSID. The identification code CD will be described with reference to FIG. 5.

The identification information processing section 303 determines whether or not the identification information of the projector 2 acquired from the SSID coincides with the identification information of the projector 2 acquired by the second communication control section 302.

The reception section 304 receives various operations from the user via the operation section 32.

### 3. Operation of Information Processing Device

Next, an operation of the information processing device 3 in the present embodiment will be described.

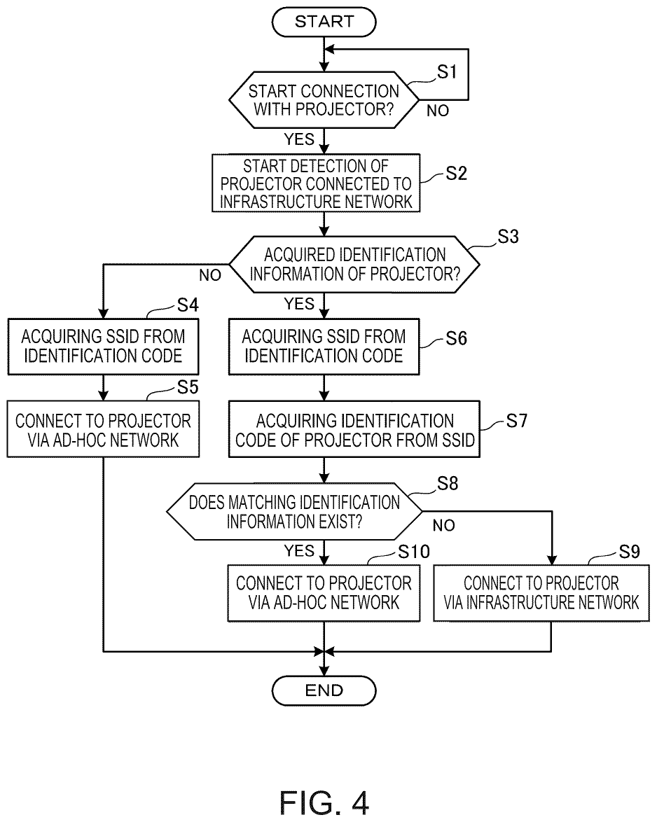

FIG. 4 is a flowchart illustrating the operation of the information processing device 3.

In the operation of the information processing device 3 described with reference to FIG. 4, the projector 2 to which the user wants to connect projects a code screen G at least before the operations of the steps S4 and S6 are performed.

FIG. 5 is a diagram illustrating an example of the code screen G.

The code screen G has the identification code CD. Although a two dimensional code is illustrated as the identification code CD in FIG. 5, the identification code CD may be a one dimensional code such as a barcode. The identification code CD records the SSID of the ad-hoc network 4 constructed by the projector 2 that displays the code screen G.

The code screen G may include identification information or the like of the projector 2. In a case where the projector 2 that displays the code screen G is the projector 2 connected to the infrastructure network 5, the code screen G may include other information such as an IP address.

Returning to the description of FIG. 4, the second communication control section 302 determines whether or not to start the connection with the projector 2 (step S1). For example, the second communication control section 302 determines to start the connection with the projector 2 when the reception section 304 receives the instruction to start the connection with the projector 2. For example, the second communication control section 302 determines that the connection with the projector 2 is started when the APP 311 starts.

When it is determined that the connection with the projector 2 is started (step S1: YES), the second communication control section 302 starts detection of the projector 2 connected to the infrastructure network 5 (step S2). More specifically, by broadcasting a device search packet, the second communication control section 302 starts receiving a response packet to the device search packet.

Next, the identification information processing section 303 determines whether or not the second communication control section 302 has acquired the identification information of the projector 2 (step S3). To describe step S3 in detail, when no response packet is received within a certain period of time after the device search packet is broadcast, the identification information processing section 303 makes a negative determination in step S3. On the other hand, when the response packet is received during a certain period and the identification information of the projector 2 is acquired from the response packet, the identification information processing section 303 makes a positive determination in step S3.

When the identification information processing section 303 determines that the second communication control section 302 has failed to acquire the identification information of the projector 2 (step S3: NO), it performs the process in step S4. That is, when the user performs imaging the identification code CD with the camera 33, the identification information processing section 303 reads the identification code CD from the imaged image obtained by the camera 33, thereby acquiring the SSDI from the identification code CD (step S4).

Next, the first communication control section 301 is connected to the projector 2 via the ad-hoc network 4 based on the SSID read in step S4 (step S5).

Returning to the description of step S3, when the identification information processing section 303 determines that the second communication control section 302 has acquired the identification information of the projector 2 (step S3: YES), it performs the process of step S4. That is, when the user performs imaging the identification code CD with the camera 33, the identification information processing section 303 reads the identification code CD from the imaged image obtained by the camera 33, thereby acquiring the SSDI from the identification code CD (step S6).

Next, the identification information processing section 303 acquires the identification information of the projector 2 from the acquired SSID (step S7).

Next, the identification information processing section 303 determines whether or not there is identification information matching the identification information of the projector 2 acquired in step S7 among the identification information of the projector 2 acquired by the second communication control section 302 (step S8).

If the identification information processing section 303 determines that there is no matching identification information (step S8: NO), the first communication control section 301 is connected to the projector 2 via the ad-hoc network 4 based on the SSID acquired in step S6 (step S9).

If the identification information processing section 303 determines that there is the matching identification information (step S8: YES), the second communication control section 302 connects the projector 2 corresponding to the identification information of the projector 2 acquired in step S7 via the infrastructure network 5 (step S10).

The operation of FIG. 4 will be described in detail with reference to FIG. 1.

When the projector 2 to which the user wants to connect is the projector 2A, the projector 2A projects the code screen G. The information processing device 3 images an image of the code screen G projected by the projector 2A with the camera 33 and acquires the SSID and the identification information of the projector 2A from the identification code CD included in the imaged image. As shown in FIG. 1, the projector 2A is connected to the infrastructure network 5. Therefore, the information processing device 3 makes the positive determination in step S8, and is connected to the projector 2A via the infrastructure network 5.

When the projector 2 to which the user wants to connect is the projector 2B, the projector 2B projects the code screen G. The information processing device 3 images an image of the code screen G projected by the projector 2B with the camera 33 and acquires the SSID and the identification information of the projector 2B from the identification code CD included in the imaged image. Here, it is assumed that the information processing device 3 is not connected to the infrastructure network 5 and the second communication control section 302 cannot acquire the identification information of the projector 2. In this case, the information processing device 3 makes the negative determination in step S3, and is connected to the projector 2B via the ad-hoc network 4B.

When the projector 2 to which the user wants to connect is the projector 2C, the projector 2C projects the code screen G. The information processing device 3 images an image of the code screen G projected by the projector 2C with the camera 33 and acquires the SSID and the identification information of the projector 2C from the identification code CD included in the imaged image. As shown in FIG. 1, the projector 2C is not connected to the infrastructure network 5. Therefore, in this case, the information processing device 3 makes the negative determination in step S8, and is connected to the projector 2C via the ad-hoc network 4C.

Next, the effects of the present embodiment will be described by exemplifying a case where the projection system 1 is used in an educational site.

In this usage scene, a case where the projectors 2A, 2B, and 2C are placed in a classroom where a class is held is illustrated.

When a teacher gives a class using the projector 2A in the classroom, the teacher connects the projector 2A and the information processing device 3. Here, in the configuration in which the projector 2 selected from the list and the information processing device 3 are connected to each other as in the related art, there is a possibility that the information processing device 3 cannot be connected to the projector 2 to which the teacher wants to connect. This is because the teacher may have selected the projector 2 to which the teacher wants to connect, by estimating the projector 2 from the list.

Therefore, the information processing device 3 according to the present embodiment determines whether or not the identification information of the projector 2 acquired from the identification code CD projected by the projector 2A matches with the identification information of the projector 2 connected to the infrastructure network 5. Then, in the case in which they coincide with each other, the information processing device 3 connects the projector 2 to the projector 2A via the infrastructure network 5 as the projector 2 to which the user wants to connect. By this, the information processing device 3 can correctly connect to the projector 2A to which the user wants to connect.

Since the connection is made via the infrastructure network 5, the information processing device 3 can be connected to the projector 2A without interrupting the download even during the download of the class. Therefore, it is possible to reduce the possibility of a situation occurring in which the class cannot proceed due to an inability to download from the infrastructure network 5 after the projector 2A is connected.

### 4. Other Embodiments

The above described embodiments are preferred embodiments of the present disclosure. However, the present disclosure is not limited to the above described embodiments, and various modifications can be made without departing from the gist of the present disclosure.

In the embodiment described above, the projection system 1 is configured to include one projector 2 that is not connected to the infrastructure network 5. However, the projection system 1 may include a plurality of projectors 2 that are not connected to the infrastructure network 5.

In the embodiment described above, the projection system 1 is configured to include two projectors 2 that is connected to the infrastructure network 5. However, the projection system 1 may include three or more projectors 2 connected to the infrastructure network 5.

In the embodiment described above, the projection system 1 includes one information processing device 3 that is connected to the infrastructure network 5. However, the projection system 1 may include a plurality of information processing devices 3 that are connected to the infrastructure network 5.

In the embodiment described above, the projection system 1 includes one projector 2 that is not connected to the infrastructure network 5. However, the projection system 1 may not include the projector 2 not connected to the infrastructure network 5, or may include a plurality of projectors 2 not connected to the infrastructure network 5.

In the embodiments described above, the projector 2 is exemplified as the “display device”, but the “display device” is not limited to the projector 2, and may be a display device that includes a touch panel and can operate a display surface of the touch panel.

The functions of the first processor 200 and the second processor 300 may be realized by a plurality of processors or a semiconductor chip.

The sections of the projector 2 illustrated in FIG. 2 and the sections of the information processing device 3 illustrated in FIG. 3 indicate functional configurations, and there are no particular limitations on the specific mounting forms. That is, hardware individually corresponding to each functional unit does not necessarily need to be mounted, and a configuration in which a plurality of functions are realized by one processor executing a program may be adopted. In the above embodiment, a part of the functions realized by software may be realized by hardware, and a part of the functions realized by hardware may be realized by software. In addition, the specific detailed configuration of each of the other sections of the projector 2 and the information processing device 3 can also be arbitrarily changed without departing from the gist of the present disclosure.

The process units of the flowchart illustrated in FIG. 4 are obtained by dividing the process of the information processing device 3 according to main process contents for easy understanding, and the present disclosure is not limited by the way of dividing the process units or the names of the process units. It may be divided into many step units according to the process content. The process may be divided so that one step unit includes many processes. The order of the steps may be changed as appropriate within a range not interfere with the gist of the present disclosure.

In a case where the control method for the information processing device 3 described above is realized using the second processor 300, it is also possible to configure a program to be executed by the second processor 300 in the form of a recording medium or a transmission medium that transmits the program. That is, the APP 311 can be realized in a state of being recorded on a portable information recording medium. Examples of the information recording medium include a magnetic recording medium such as a hard disk, an optical recording medium such as a CD, and a semiconductor storage device such as a Universal Serial Bus (USB) memory or a Solid State Drive (SSD), but other recording media can also be used.

### 5. Summary of Present Disclosure

Hereinafter, a summary of the present disclosure is appended.

### Appendix 1

A control method for an information processing device connected to an infrastructure network, the control method including acquiring, via the infrastructure network, identification information of a first display device connected to the infrastructure network and identification information of a second display device connected to the infrastructure network; by reading an identification code displayed by a display device to which a user wants to connect, acquiring identification information of the display device from the identification code; and when the identification information of the display device and the identification information of the first display device match each other, connecting, via the infrastructure network, to the first display device as the display device.

According to this, among the display devices connected to the infrastructure network, the display device whose identification code matches the identification information of the display device that displays the identification code is connected via the infrastructure network. Therefore, the information processing device can correctly connect to the display device to which the user wants to connect. Since the information processing device is connected to the display device via the infrastructure network, the information processing device can be connected to the display device without interrupting the download even during the download of data via the infrastructure network.

### Appendix 2

The control method of the information processing device according to the Appendix 1, further including when the identification information of the display device does not match the identification information of the first display device and the identification information of the second display device, connecting to the display device via an ad-hoc network.

According to this, when there is no display device that matches the identification information of the display device that displays the identification code among the display devices connected to the infrastructure network, the display device is connected to the display device that displays the identification code via the ad-hoc network. Therefore, when the display device to which the user wants to connect is not connected to the infrastructure network, the information processing device can connect to the display device to which the user wants to connect even if the user does not perform an additional operation.

### Appendix 3

The method for controlling an information processing device according to Appendix 1 or Appendix 2, further including when the identification information of the first display device and the identification information of the second display device cannot be acquired, connecting to the display device via an ad-hoc network.

According to this, when the identification information of the display device connected to the infrastructure network cannot be acquired, the display device is connected to the display device displaying the identification code via the ad-hoc network. Therefore, when the display device to which the user wants to connect is not connected to the infrastructure network or when the information processing device is not connected to the infrastructure network, the information processing device can connect to the display device to which the user wants to connect without the user performing an additional operation.

### Appendix 4

A display system includes an information processing device and display devices that are connected to an infrastructure network, wherein the information processing device acquires, via the infrastructure network, identification information of a first display device connected to the infrastructure network and identification information of a second display device connected to the infrastructure network, by reading an identification code displayed by a display device to which a user wants to connect, acquires identification information of the display device from the identification code; and when the identification information of the display device and the identification information of the first display device match each other, connecting, via the infrastructure network, to the first display device as the display device.

According to this, the same effect as the control method of the information processing device according to Appendix 1 is achieved.

### Appendix 5

The display system according to Appendix 4, wherein the information processing device acquires the identification information of the display device after acquiring the identification information of the first display device and the identification information of the second display device.

By this, by acquiring the identification information of the display device connected to the infrastructure network in advance, it is possible to quickly determine whether or not the identification information matches after acquiring the identification information of the display device that displays the identification code. Therefore, the information processing device can shorten the time until connection with the display device.

### Appendix 6

The program causes a processor of an information processing device connected to an infrastructure network to acquire identification information of a first display device connected to the infrastructure network and identification information of a second display device connected to the infrastructure network via the infrastructure network, acquire identification information of the display device from an identification code by reading the identification code displayed by a display device to which a user wants to connect, and when the identification information of the display device and the identification information of the first display device match each other, connect, via the infrastructure network, to the first display device as the display device.

According to this, the same effect as the control method of the information processing device according to Appendix 1 is achieved.

What is claimed is:

1. A control method for an information processing device connected to an infrastructure network, the control method comprising:
acquiring, via the infrastructure network, identification information of a first display device connected to the infrastructure network and identification information of a second display device connected to the infrastructure network;
by reading an identification code displayed by a display device to which a user wants to connect, acquiring identification information of the display device from the identification code; and
when the identification information of the display device and the identification information of the first display device match each other, connecting, via the infrastructure network, to the first display device as the display device.

2. The control method for the information processing device according to claim 1, further comprising:
when the identification information of the display device does not match the identification information of the first display device and the identification information of the second display device, connecting to the display device via an ad-hoc network.

3. The control method for the information processing device according to claim 1, further comprising:
when the identification information of the first display device and the identification information of the second display device cannot be acquired, connecting to the display device via an ad-hoc network.

4. A display system comprising:
an information processing device and display devices that are connected to an infrastructure network, wherein
the information processing device
acquires, via the infrastructure network, identification information of a first display device connected to the infrastructure network and identification information of a second display device connected to the infrastructure network,
by reading an identification code displayed by a display device to which a user wants to connect, acquires identification information of the display device from the identification code, and
when the identification information of the display device and the identification information of the first display device match each other, connecting, via the infrastructure network, to the first display device as the display device.

5. The display system according to claim 4, wherein
the information processing device
acquires the identification information of the display device after acquiring the identification information of the first display device and the identification information of the second display device.

6. A non-transitory computer-readable storage medium storing a program, wherein
the program causes a processor of an information processing device connected to an infrastructure network to
acquire identification information of a first display device connected to the infrastructure network and identification information of a second display device connected to the infrastructure network via the infrastructure network,
acquire identification information of the display device from an identification code by reading the identification code displayed by a display device to which a user wants to connect, and
when the identification information of the display device and the identification information of the first display device match each other, connect, via the infrastructure network, to the first display device as the display device.
